(19) United States
(12) Patent Application Publication
(10) Pub. No.: US 2025/0173213 A1
(43) Pub. Date: May 29, 2025

(54) DYNAMIC SELECTION OF SYSTEM TO DEPLOY APPLICATION BASED ON SELECTED EVENT

(71) Applicant: INTERNATIONAL BUSINESS MACHINES CORPORATION, Armonk, NY (US)

(72) Inventors: Travis JANSSEN, San Jose, CA (US); Veeraraghavan Walajapet DEENADHAYALAN, San Jose, CA (US); Brian D. HATFIELD, Tucson, AZ (US)

(21) Appl. No.: 18/521,139

(22) Filed: Nov. 28, 2023

(51) Int. Cl. G06F 11/07; G06F 11/30

(52) U.S. Cl. CPC G06F 11/0793; G06F 11/3051

(57) ABSTRACT

User-defined information relating to recovery of an application is obtained, based on a selected event. Data relating to a set of candidate systems available to deploy the application is obtained. The data includes one or more system statistics for the set of candidate systems, and the one or more system statistics include, at least, one or more recovery point actuals and historical data for the set of candidate systems. A scoring of the set of candidate systems is performed based on the user-defined information and the data that is obtained. A candidate system is selected from the set of candidate systems based on the scoring. Deployment of the application on the candidate system that is selected is initiated.

### BACKGROUND

One or more aspects relate, in general, to facilitating processing within a computing environment, and in particular, to facilitating recovery within the computing environment.

Applications executing on systems of the computing environment may be affected by certain events, such as natural disasters. In these scenarios, recovery is to be performed to restore execution of the applications. During recovery, application downtime and data loss are to be minimized. However, there may be tradeoffs between these and other goals, such as maintaining application performance.

Currently, there are various available disaster recovery techniques, including static disaster recovery plans, load balancers and disaster recovery orchestrators. Static disaster recovery plans are interpreted and executed by a human and consider limited information, such as data loss. Load balancers consider some performance-related information that affect recovery time and post-recovery performance, but not data loss or other considerations. Disaster recovery orchestrators consider potential data loss from configuration including recovery point objectives, but not actual data loss or other system information.

Although there are current disaster recovery techniques, further improvements are desired when recovering one or more applications based on occurrence of certain events.

### SUMMARY

Shortcomings of the prior art are overcome, and additional advantages are provided through the provision of a computer program product for facilitating processing within a computing environment. The computer program product includes at least one computer readable storage medium and program instructions collectively stored on the at least one computer readable storage medium. The program instructions collectively stored include program instructions to obtain user-defined information relating to recovery of an application based on a selected event, and program instructions to obtain data relating to a set of candidate systems available to deploy the application. The data includes one or more system statistics for the set of candidate systems. The one or more system statistics include, at least, one or more recovery point actuals and historical data for the set of candidate systems. The program instructions collectively stored further include program instructions to perform a scoring of the set of candidate systems based on the user-defined information and the data that is obtained, and program instructions to select a candidate system from the set of candidate systems based on the scoring. Further, the program instructions collectively stored include program instructions to initiate deployment of the application on the candidate system that is selected.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies.

In one or more embodiments, the user-defined information includes relative importance to a user of at least one system statistic of the one or more system statistics of one or more candidate systems of the set of candidate systems. Consideration of user-defined information enables dynamic selection of a candidate system based on relative importance of certain system statistics and/or goals of the user.

In one or more embodiments, the user-defined information includes one or more user-identified statistics. As an example, the one or more user-identified statistics include an indication of a valuation function to be used to valuate at least one system statistic of the one or more system statistics of one or more candidate systems of the set of candidate systems. The use of user-identified statistics enables the user to specify how to valuate one or more system statistics and/or goals enhancing usefulness of the application, post-recovery, to the user.

As an example, the one or more system statistics further include one or more resource availability metrics for a set of system resources for at least one candidate system of the set of candidate systems. In one embodiment, the set of system resources includes memory, one or more central processing units, input/output bandwidth and latency. As another example, the one or more system statistics further include a degree of recovery completed for the application. Consideration of resource availability metrics and/or degree of recovery completed for the application facilitates selection of a candidate system in which the application may best perform.

In one or more embodiments, the program instructions to obtain the data include program instructions to obtain the data based on occurrence of the selected event. This allows the data to be obtained at the time in which the selected event occurs, allowing the most up-to-date data to be obtained and used in the selection of the candidate system.

In one or more embodiments, the set of candidate systems includes a current system on which the application is deployed and one or more other candidate systems. The inclusion of the current system in the set of candidate systems improves selection options and advantageously enables the application to remain on the same system such that data loss is avoided.

In one or more embodiments, the application is a stateful application, and application data of the application is protected using one or more data protection techniques. The selection of the candidate system is independent of the one or more data protection techniques. This allows the recovery technique to be used with a wide variety of data protection techniques.

In one or more embodiments, the scoring is based on selected data relating to application downtime, current resource availability of the set of candidate systems, time it takes to recover the application, post-recovery performance and estimated post-recovery resource availability. By considering a plurality of system statistics and/or goals in selecting a candidate system, the speed at which the application is recovered is increased, as well as performance of the application, post-recovery.

In one or more embodiments, the program instructions to perform the scoring include program instructions to perform a weighting of at least one system statistic of the one or more system statistics based on the user-defined information to obtain one or more weighted values. The program instructions to perform the scoring include program instructions to use the one or more weighted values in the scoring. The weighting allows the user to have input on the importance of one or more system statistics enabling the application to be recovered in a manner that benefits the user.

In one or more embodiments, the historical data includes one or more historical recovery time statistics for one or more candidate systems of the set of candidate systems. The use of historical recovery time statistics provides a more robust recovery technique that includes a comprehensive review of information in making a selection.

In one or more embodiments, the one or more recovery point actuals include at least one recovery point actual for each candidate system of the set of candidate systems. This provides additional data for each candidate system to be considered.

In one or more embodiments, the selected event is disaster recovery from a natural disaster. A comprehensive recovery mechanism is provided to recover from natural disasters. This mechanism is dynamic, allowing a user to have input on the importance of certain criteria in a failover.

In accordance with one or more aspects, each of the embodiments is separable and optional from one another. Further, aspects of an embodiment are separable/optional from each other. Moreover, embodiments may be combined with one another.

In one aspect, a computer system for facilitating processing within a computing environment is provided. The computer system includes a memory and at least one device coupled to the memory. The computer system is configured to perform a method. The method includes obtaining user-defined information relating to recovery of an application based on a selected event and obtaining data relating to a set of candidate systems available to deploy the application. The data includes one or more system statistics for the set of candidate systems. The one or more system statistics include, at least, one or more recovery point actuals and historical data for the set of candidate systems. A scoring of the set of candidate systems is performed based on the user-defined information and the data that is obtained. A candidate system is selected from the set of candidate systems based on the scoring, and deployment of the application on the candidate system that is selected is initiated.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies.

In one or more embodiments, the user-defined information includes relative importance to a user of at least one system statistic of the one or more system statistics of one or more candidate systems of the set of candidate systems. Consideration of user-defined information enables dynamic selection of a candidate system based on relative importance of certain system statistics and/or goals of the user.

In one or more embodiments, the scoring is based on selected data relating to application downtime, current resource availability of the set of candidate systems, time it takes to recover the application, post-recovery performance and estimated post-recovery resource availability. By considering a plurality of system statistics and/or goals in selecting a candidate system, the speed at which the application is recovered is increased, as well as performance of the application, post-recovery.

In one or more embodiments, the performing the scoring includes performing a weighting of at least one system statistic of the one or more system statistics based on the user-defined information to obtain one or more weighted values. The performing the scoring includes using the one or more weighted values in the scoring. The weighting allows the user to have input on the importance of one or more system statistics enabling the application to be recovered in a manner that benefits the user.

In one or more embodiments, the application is a stateful application, and application data of the application is protected using one or more data protection techniques. The selection of the candidate system is independent of the one or more data protection techniques. This allows the recovery technique to be used with a wide variety of data protection techniques.

In accordance with one or more aspects, each of the embodiments is separable and optional from one another. Further, aspects of an embodiment are separable/optional from each other. Moreover, embodiments may be combined with one another.

In one aspect, a computer-implemented method of facilitating processing within a computing environment is provided. The computer-implemented method includes obtaining user-defined information relating to recovery of an application based on a selected event, and obtaining data relating to a set of candidate systems available to deploy the application. The data includes one or more system statistics for the set of candidate systems. The one or more system statistics include, at least, one or more recovery point actuals and historical data for the set of candidate systems. A scoring of the set of candidate systems is performed based on the user-defined information and the data that is obtained. A candidate system is selected from the set of candidate systems based on the scoring, and deployment of the application on the candidate system that is selected is initiated.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies.

In one or more embodiments, the user-defined information includes relative importance to a user of at least one system statistic of the one or more system statistics of one or more candidate systems of the set of candidate systems. Consideration of user-defined information enables dynamic selection of a candidate system based on relative importance of certain system statistics and/or goals of the user.

In one or more embodiments, the application is a stateful application, and application data of the application is protected using one or more data protection techniques. The selection of the candidate system is independent of the one or more data protection techniques. This allows the recovery technique to be used with a wide variety of data protection techniques.

In one or more embodiments, the scoring is based on selected data relating to application downtime, current resource availability of the set of candidate systems, time it takes to recover the application, post-recovery performance and estimated post-recovery resource availability. By considering a plurality of system statistics and/or goals in selecting a candidate system, the speed at which the application is recovered is increased, as well as performance of the application, post-recovery.

In one or more embodiments, the performing the scoring includes performing a weighting of at least one system statistic of the one or more system statistics based on the user-defined information to obtain one or more weighted values. The performing the scoring includes using the one or more weighted values in the scoring. The weighting allows the user to have input on the importance of one or more system statistics enabling the application to be recovered in a manner that benefits the user.

In accordance with one or more aspects, each of the embodiments is separable and optional from one another. Further, aspects of an embodiment are separable/optional from each other. Moreover, embodiments may be combined with one another.

In one or more aspects, a computer program product, computer system and computer-implemented method of facilitating processing within a computing environment are provided. In one or more embodiments, user-defined information relating to recovery of an application based on a selected event is obtained. Data relating to a set of candidate systems available to deploy the application is obtained. The data includes one or more system statistics for the set of candidate systems, and the one or more system statistics include, at least, one or more recovery point actuals and historical data for the set of candidate systems. The user-defined information includes relative importance to a user of at least one system statistic of the one or more system statistics of one or more candidate systems of the set of candidate systems. A scoring of the set of candidate systems is performed based on the user-defined information and the data that is obtained. A candidate system is selected from the set of candidate systems based on the scoring, and deployment of the application is initiated on the candidate system that is selected.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies. Further, consideration of user-defined information enables dynamic selection of a candidate system based on relative importance of certain system statistics and/or goals of the user.

In one or more aspects, a computer program product, computer system and computer-implemented method of facilitating processing within a computing environment are provided. In one or more embodiments, user-defined information relating to recovery of an application based on a selected event is obtained. Data relating to a set of candidate systems available to deploy the application is obtained. The data includes one or more system statistics for the set of candidate systems, and the one or more system statistics include, at least, one or more recovery point actuals, historical data for the set of candidate systems, one or more resource availability metrics for a set of system resources for at least one candidate system of the set of candidate systems and a degree of completed recovery for the application. A scoring of the set of candidate systems is performed based on the user-defined information and the data that is obtained. A candidate system is selected from the set of candidate systems based on the scoring, and deployment of the application is initiated on the candidate system that is selected.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies. Consideration of resource availability metrics and/or degree of recovery completed for the application facilitates selection of a candidate system in which the application may best perform.

In one or more embodiments, the user-defined information includes relative importance to a user of at least one system statistic of the one or more system statistics of one or more candidate systems of the set of candidate systems. Consideration of user-defined information enables dynamic selection of a candidate system based on relative importance of certain system statistics and/or goals of the user.

In one or more aspects, a computer program product, computer system and computer-implemented method of facilitating processing within a computing environment are provided. In one or more embodiments, user-defined information relating to recovery of an application based on a selected event is obtained. Data relating to a set of candidate systems available to deploy the application is obtained. The data includes one or more system statistics for the set of candidate systems, and the one or more system statistics include, at least, one or more recovery point actuals and historical data for the set of candidate systems. The user-defined information includes relative importance to a user of at least one system statistic of the one or more system statistics of one or more candidate systems of the set of candidate systems. A scoring of the set of candidate systems is performed based on the user-defined information and the data that is obtained. A candidate system is selected from the set of candidate systems based on the scoring, and deployment of the application is initiated on the candidate system that is selected. In one example, the application is a stateful application, and application data of the application is protected using one or more data protection techniques. The selection of the candidate system is independent of the one or more data protection techniques.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies. Consideration of user-defined information enables dynamic selection of a candidate system based on relative importance of certain system statistics and/or goals of the user. The selection of a candidate system independent of data protection techniques allows the recovery technique to be used with a wide variety of data protection techniques.

In one or more aspects, a computer program product, computer system and computer-implemented method of facilitating processing within a computing environment are provided. In one or more embodiments, user-defined information relating to recovery of an application based on a selected event is obtained. Data relating to a set of candidate systems available to deploy the application is obtained. The data includes one or more system statistics for the set of candidate systems, and the one or more system statistics include, at least, one or more recovery point actuals and historical data for the set of candidate systems. The user-defined information includes relative importance to a user of at least one system statistic of the one or more system statistics of one or more candidate systems of the set of candidate systems. A scoring of the set of candidate systems is performed based on the user-defined information and the data that is obtained. The scoring is based on selected data relating to application downtime, current resource availability of the set of candidate systems, time it takes to recover the application, post-recovery performance and estimated post-recovery resource availability. A candidate system is selected from the set of candidate systems based on the scoring, and deployment of the application is initiated on the candidate system that is selected.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies. Consideration of user-defined information enables dynamic selection of a candidate system based on relative importance of certain system statistics and/or goals of the user. By considering a plurality of system statistics and/or goals in selecting a candidate system, the speed at which the application is recovered is increased, as well as performance of the application, post-recovery.

In one or more aspects, a computer program product, computer system and computer-implemented method of facilitating processing within a computing environment are provided. In one or more embodiments, user-defined information relating to recovery of an application based on a selected event is obtained. Data relating to a set of candidate systems available to deploy the application is obtained. The data includes one or more system statistics for the set of candidate systems, and the one or more system statistics include, at least, one or more recovery point actuals and historical data for the set of candidate systems. The historical data includes historical recovery time statistics for one or more candidate systems of the set of candidate systems. The user-defined information includes relative importance to a user of at least one system statistic of the one or more system statistics of one or more candidate systems of the set of candidate systems. A scoring of the set of candidate systems is performed based on the user-defined information and the data that is obtained. A candidate system is selected from the set of candidate systems based on the scoring, and deployment of the application is initiated on the candidate system that is selected.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies. Consideration of user-defined information enables dynamic selection of a candidate system based on relative importance of certain system statistics and/or goals of the user. The use of historical recovery time statistics provides a more robust recovery technique that includes a comprehensive review of information in making a selection.

In accordance with one or more aspects, each of the embodiments is separable and optional from one another. Further, aspects of an embodiment are separable/optional from each other. Moreover, embodiments may be combined with one another.

Computer-implemented methods, systems and computer program products relating to one or more aspects are described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate, perform and/or use one or more aspects of the present disclosure;

FIG. 2 depicts examples of failure domains, in accordance with one or more aspects of the present disclosure;

FIG. 3 depicts one example of using a recovery controller in performing failover recovery, in accordance with one or more aspects of the present disclosure;

FIG. 4 depicts one example of sub-modules of a recovery module of FIG. 1, in accordance with one or more aspects of the present disclosure; and

FIG. 5 depicts one example of a recovery process, in accordance with one or more aspects of the present disclosure.

### DETAILED DESCRIPTION

In accordance with one or more aspects of the present disclosure, a capability is provided to facilitate processing within a computing environment. In one aspect, processing is facilitated by providing a recovery capability that includes dynamic selection of a system (also referred to herein as a candidate system) to deploy one or more applications based on a selected event. As an example, the selected event is disaster recovery from a natural disaster, but other selected events are possible.

When a selected event occurs, such as disaster recovery due to a disaster (e.g., natural disaster), application downtime and data loss, as examples, are to be minimized. However, there may be tradeoffs between these and other goals, such as maintaining application performance. Thus, determinations are made of how to collect information to be used to provide a solution in such a scenario and how to choose which candidate system on which to deploy an application when multiple candidate systems are available. A detailed recovery plan is provided that considers the tradeoffs.

In one or more aspects, a comprehensive recovery solution is to consider, for instance, data loss, application downtime, performance-related information affecting recovery time and/or post-recovery performance, and any user-defined information; quickly recommend an action plan based on obtained data (e.g., system statistics) relating to candidate systems on which an application may be deployed; and optionally, execute the recommendation.

Although there are known disaster recovery techniques, those techniques are not comprehensive. For instance, static disaster recovery plans are interpreted and executed by a human, not a computer, and consider limited information, e.g., data loss. Further, load balancers consider some performance-related information that affect recovery time and post-recovery performance i.e., central processing unit (CPU) and memory availability, but not, e.g., input/output (I/O) bandwidth, historical recovery times, or data loss. Yet further, disaster recovery orchestrators consider potential data loss from configuration including recovery point objectives, but not actual data loss or other system information e.g., CPU and memory availability, I/O bandwidth, and historical recovery times. Therefore, in accordance with one or more aspects, a dynamic and comprehensive disaster recovery system is provided that automatically considers, for instance, data loss, application downtime, performance-related information affecting recovery time and/or post-recovery performance, as well as any user-defined information (e.g., relative importance of, e.g., one or more system statistics of the candidate systems and/or user-defined statistics, etc.).

In one or more aspects, a computer program product for facilitating processing within a computing environment is provided. The computer program product includes at least one computer readable storage medium and program instructions collectively stored on the at least one computer readable storage medium. The program instructions collectively stored include program instructions to obtain user-defined information relating to recovery of an application based on a selected event, and program instructions to obtain data relating to a set of candidate systems available to deploy the application. The data includes one or more system statistics for the set of candidate systems. The one or more system statistics include, at least, one or more recovery point actuals and historical data for the set of candidate systems. The program instructions collectively stored further include program instructions to perform a scoring of the set of candidate systems based on the user-defined information and the data that is obtained, and program instructions to select a candidate system from the set of candidate systems based on the scoring. Further, the program instructions collectively stored include program instructions to initiate deployment of the application on the candidate system that is selected.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies.

Additionally, or alternatively, in one or more embodiments, the user-defined information includes relative importance to a user of at least one system statistic of the one or more system statistics of one or more candidate systems of the set of candidate systems. Consideration of user-defined information enables dynamic selection of a candidate system based on relative importance of certain system statistics and/or goals of the user.

Additionally, or alternatively, in one or more embodiments, the user-defined information includes one or more user-identified statistics. As an example, the one or more user-identified statistics include an indication of a valuation function to be used to valuate at least one system statistic of the one or more system statistics of one or more candidate systems of the set of candidate systems. The use of user-identified statistics enables the user to specify how to valuate one or more system statistics and/or goals enhancing usefulness of the application, post-recovery, to the user.

Additionally, or alternatively, as an example, the one or more system statistics further include one or more resource availability metrics for a set of system resources for at least one candidate system of the set of candidate systems. In one embodiment, the set of system resources includes memory, one or more central processing units, input/output bandwidth and latency. As another example, the one or more system statistics further include a degree of recovery completed for the application. Consideration of resource availability metrics and/or degree of recovery completed for the application facilitates selection of a candidate system in which the application may best perform.

Additionally, or alternatively, in one or more embodiments, the program instructions to obtain the data include program instructions to obtain the data based on occurrence of the selected event. This allows the data to be obtained at the time in which the selected event occurs, allowing the most up-to-date data to be obtained and used in the selection of the candidate system.

Additionally, or alternatively, in one or more embodiments, the set of candidate systems includes a current system on which the application is deployed and one or more other candidate systems. The inclusion of the current system in the set of candidate systems improves selection options and advantageously enables the application to remain on the same system such that data loss is avoided.

Additionally, or alternatively, in one or more embodiments, the application is a stateful application, and application data of the application is protected using one or more data protection techniques. The selection of the candidate system is independent of the one or more data protection techniques. This allows the recovery technique to be used with a wide variety of data protection techniques.

Additionally, or alternatively, in one or more embodiments, the scoring is based on selected data relating to application downtime, current resource availability of the set of candidate systems, time it takes to recover the application, post-recovery performance and estimated post-recovery resource availability. By considering a plurality of system statistics and/or goals in selecting a candidate system, the speed at which the application is recovered is increased, as well as performance of the application, post-recovery.

Additionally, or alternatively, in one or more embodiments, the program instructions to perform the scoring include program instructions to perform a weighting of at least one system statistic of the one or more system statistics based on the user-defined information to obtain one or more weighted values. The program instructions to perform the scoring include program instructions to use the one or more weighted values in the scoring. The weighting allows the user to have input on the importance of one or more system statistics enabling the application to be recovered in a manner that benefits the user.

Additionally, or alternatively, in one or more embodiments, the historical data includes one or more historical recovery time statistics for one or more candidate systems of the set of candidate systems. The use of historical recovery time statistics provides a more robust recovery technique that includes a comprehensive review of information in making a selection.

Additionally, or alternatively, in one or more embodiments, the one or more recovery point actuals include at least one recovery point actual for each candidate system of the set of candidate systems. This provides additional data for each candidate system to be considered.

Additionally, or alternatively, in one or more embodiments, the selected event is disaster recovery from a natural disaster. A comprehensive recovery mechanism is provided to recover from natural disasters. This mechanism is dynamic, allowing a user to have input on the importance of certain criteria in failover.

In accordance with one or more aspects, each of the embodiments is separable and optional from one another. Further, aspects of an embodiment are separable/optional from each other. Moreover, embodiments may be combined with one another.

In one aspect, a computer system for facilitating processing within a computing environment is provided. The computer system includes a memory and at least one device coupled to the memory. The computer system is configured to perform a method. The method includes obtaining user-defined information relating to recovery of an application based on a selected event and obtaining data relating to a set of candidate systems available to deploy the application. The data includes one or more system statistics for the set of candidate systems. The one or more system statistics include, at least, one or more recovery point actuals and historical data for the set of candidate systems. A scoring of the set of candidate systems is performed based on the user-defined information and the data that is obtained. A candidate system is selected from the set of candidate systems based on the scoring, and deployment of the application on the candidate system that is selected is initiated.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies.

Additionally, or alternatively, in one or more embodiments, the user-defined information includes relative importance to a user of at least one system statistic of the one or more system statistics of one or more candidate systems of the set of candidate systems. Consideration of user-defined information enables dynamic selection of a candidate system based on relative importance of certain system statistics and/or goals of the user.

Additionally, or alternatively, in one or more embodiments, the scoring is based on selected data relating to application downtime, current resource availability of the set of candidate systems, time it takes to recover the application, post-recovery performance and estimated post-recovery resource availability. By considering a plurality of system statists and/or goals in selecting a candidate system, the speed at which the application is recovered is increased, as well as performance of the application, post-recovery.

Additionally, or alternatively, in one or more embodiments, the performing the scoring includes performing a weighting of at least one system statistic of the one or more system statistics based on the user-defined information to obtain one or more weighted values. The performing the scoring includes using the one or more weighted values in the scoring. The weighting allows the user to have input on the importance of one or more system statistics enabling the application to be recovered in a manner that benefits the user.

Additionally, or alternatively, in one or more embodiments, the application is a stateful application, and application data of the application is protected using one or more data protection techniques. The selection of the candidate system is independent of the one or more data protection techniques. This allows the recovery technique to be used with a wide variety of data protection techniques.

In accordance with one or more aspects, each of the embodiments is separable and optional from one another. Further, aspects of an embodiment are separable/optional from each other. Moreover, embodiments may be combined with one another.

In one aspect, a computer-implemented method of facilitating processing within a computing environment is provided. The computer-implemented method includes obtaining user-defined information relating to recovery of an application based on a selected event, and obtaining data relating to a set of candidate systems available to deploy the application. The data includes one or more system statistics for the set of candidate systems. The one or more system statistics include, at least, one or more recovery point actuals and historical data for the set of candidate systems. A scoring of the set of candidate systems is performed based on the user-defined information and the data that is obtained. A candidate system is selected from the set of candidate systems based on the scoring, and deployment of the application on the candidate system that is selected is initiated.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies.

Additionally, or alternatively, in one or more embodiments, the user-defined information includes relative importance to a user of at least one system statistic of the one or more system statistics of one or more candidate systems of the set of candidate systems. Consideration of user-defined information enables dynamic selection of a candidate system based on relative importance of certain system statistics and/or goals of the user.

Additionally, or alternatively, in one or more embodiments, the application is a stateful application, and application data of the application is protected using one or more data protection techniques. The selection of the candidate system is independent of the one or more data protection techniques. This allows the recovery technique to be used with a wide variety of data protection techniques.

Additionally, or alternatively, in one or more embodiments, the scoring is based on selected data relating to application downtime, current resource availability of the set of candidate systems, time it takes to recover the application, post-recovery performance and estimated post-recovery resource availability. By considering a plurality of system statistics and/or goals in selecting a candidate system, the speed at which the application is recovered is increased, as well as performance of the application, post-recovery.

Additionally, or alternatively, in one or more embodiments, the performing the scoring includes performing a weighting of at least one system statistic of the one or more system statistics based on the user-defined information to obtain one or more weighted values. The performing the scoring includes using the one or more weighted values in the scoring. The weighting allows the user to have input on the importance of one or more system statistics enabling the application to be recovered in a manner that benefits the user.

In accordance with one or more aspects, each of the embodiments is separable and optional from one another. Further, aspects of an embodiment are separable/optional from each other. Moreover, embodiments may be combined with one another.

In one or more aspects, a computer program product, computer system and computer-implemented method of facilitating processing within a computing environment are provided. In one or more embodiments, user-defined information relating to recovery of an application based on a selected event is obtained. Data relating to a set of candidate systems available to deploy the application is obtained. The data includes one or more system statistics for the set of candidate systems, and the one or more system statistics include, at least, one or more recovery point actuals and historical data for the set of candidate systems. The user-defined information includes relative importance to a user of at least one system statistic of the one or more system statistics of one or more candidate systems of the set of candidate systems. A scoring of the set of candidate systems is performed based on the user-defined information and the data that is obtained. A candidate system is selected from the set of candidate systems based on the scoring, and deployment of the application is initiated on the candidate system that is selected.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies. Further, consideration of user-defined information enables dynamic selection of a candidate system based on relative importance of certain system statistics and/or goals of the user.

In one or more aspects, a computer program product, computer system and computer-implemented method of facilitating processing within a computing environment are provided. In one or more embodiments, user-defined information relating to recovery of an application based on a selected event is obtained. Data relating to a set of candidate systems available to deploy the application is obtained. The data includes one or more system statistics for the set of candidate systems, and the one or more system statistics include, at least, one or more recovery point actuals, historical data for the set of candidate systems, one or more resource availability metrics for a set of system resources for at least one candidate system of the set of candidate systems and a degree of completed recovery for the application. A scoring of the set of candidate systems is performed based on the user-defined information and the data that is obtained. A candidate system is selected from the set of candidate systems based on the scoring, and deployment of the application is initiated on the candidate system that is selected.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies. Consideration of resource availability metrics and/or degree of recovery completed for the application facilitates selection of a candidate system in which the application may best perform.

Additionally, or alternatively, in one or more embodiments, the user-defined information includes relative importance to a user of at least one system statistic of the one or more system statistics of one or more candidate systems of the set of candidate systems. Consideration of user-defined information enables dynamic selection of a candidate system based on relative importance of certain system statistics and/or goals of the user.

In one or more aspects, a computer program product, computer system and computer-implemented method of facilitating processing within a computing environment are provided. In one or more embodiments, user-defined information relating to recovery of an application based on a selected event is obtained. Data relating to a set of candidate systems available to deploy the application is obtained. The data includes one or more system statistics for the set of candidate systems, and the one or more system statistics include, at least, one or more recovery point actuals and historical data for the set of candidate systems. The user-defined information includes relative importance to a user of at least one system statistic of the one or more system statistics of one or more candidate systems of the set of candidate systems. A scoring of the set of candidate systems is performed based on the user-defined information and the data that is obtained. A candidate system is selected from the set of candidate systems based on the scoring, and deployment of the application is initiated on the candidate system that is selected. In one example, the application is a stateful application, and application data of the application is protected using one or more data protection techniques. The selection of the candidate system is independent of the one or more data protection techniques.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies. Consideration of user-defined information enables dynamic selection of a candidate system based on relative importance of certain system statistics and/or goals of the user. The selection of a candidate system independent of data protection techniques allows the recovery technique to be used with a wide variety of data protection techniques.

In one or more aspects, a computer program product, computer system and computer-implemented method of facilitating processing within a computing environment are provided. In one or more embodiments, user-defined information relating to recovery of an application based on a selected event is obtained. Data relating to a set of candidate systems available to deploy the application is obtained. The data includes one or more system statistics for the set of candidate systems, and the one or more system statistics include, at least, one or more recovery point actuals and historical data for the set of candidate systems. The user-defined information includes relative importance to a user of at least one system statistic of the one or more system statistics of one or more candidate systems of the set of candidate systems. A scoring of the set of candidate systems is performed based on the user-defined information and the data that is obtained. The scoring is based on selected data relating to application downtime, current resource availability of the set of candidate systems, time it takes to recover the application, post-recovery performance and estimated post-recovery resource availability. A candidate system is selected from the set of candidate systems based on the scoring, and deployment of the application is initiated on the candidate system that is selected.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies. Consideration of user-defined information enables dynamic selection of a candidate system based on relative importance of certain system statistics and/or goals of the user. By considering a plurality of system statistics and/or goals in selecting a candidate system, the speed at which the application is recovered is increased, as well as performance of the application, post-recovery.

In one or more aspects, a computer program product, computer system and computer-implemented method of facilitating processing within a computing environment are provided. In one or more embodiments, user-defined information relating to recovery of an application based on a selected event is obtained. Data relating to a set of candidate systems available to deploy the application is obtained. The data includes one or more system statistics for the set of candidate systems, and the one or more system statistics include, at least, one or more recovery point actuals and historical data for the set of candidate systems. The historical data includes historical recovery time statistics for one or more candidate systems of the set of candidate systems. The user-defined information includes relative importance to a user of at least one system statistic of the one or more system statistics of one or more candidate systems of the set of candidate systems. A scoring of the set of candidate systems is performed based on the user-defined information and the data that is obtained. A candidate system is selected from the set of candidate systems based on the scoring, and deployment of the application is initiated on the candidate system that is selected.

By considering system statistics in selecting a candidate system, a comprehensive and intelligent selection/recovery solution based on a plurality of criteria is provided. Such a solution is beneficial when there are, for instance, multiple recovery points available in multiple candidate systems, in multiple locations, including the cloud. Further, in considering historical data, a single point in time is not relied upon, reducing the possibility of inaccuracies. Consideration of user-defined information enables dynamic selection of a candidate system based on relative importance of certain system statistics and/or goals of the user. The use of historical recovery time statistics provides a more robust recovery technique that includes a comprehensive review of information in making a selection.

In accordance with one or more aspects, each of the embodiments is separable and optional from one another. Further, aspects of an embodiment are separable/optional from each other. Moreover, embodiments may be combined with one another.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) to, e.g., select a candidate system to recover an application, perform recovery and/or perform one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

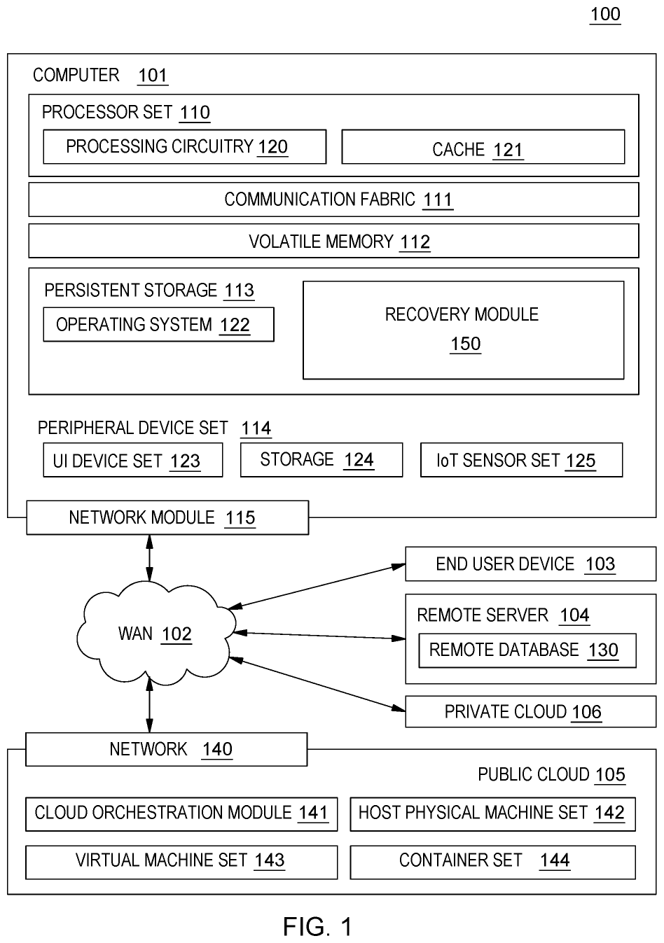

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as recovery code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

In accordance with one or more aspects, processors and/or machines of a computing environment may be located at different sites. A site may be geographically close to one or more other sites and/or geographically distant from one or more other sites. In one or more examples, at least one site may be a cloud environment. Many examples are possible. A site may be considered a failover site, which is used for application failover if there is a selected event, such as disaster recovery, due to a disaster at another site. The disaster is, for instance a natural disaster including, but not limited to, an earthquake; tsunami; flood; volcanic eruption; landslide; fire; weather related disaster, such as a hurricane, blizzard, tornado, cyclone, monsoon, etc.; and/or other natural disasters. In other examples, the disaster may be other types of disasters and/or the selected event may be other types of selected events.

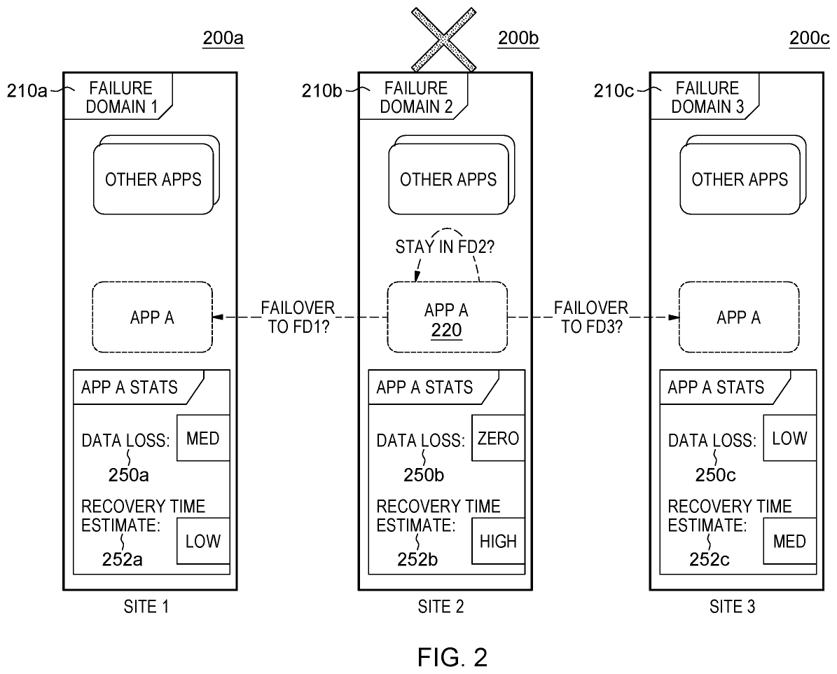

One example of multiple failover sites is depicted in FIG. 2. In one example, there are multiple sites, including, for instance, site 1 (200a), site 2 (200b) and site 3 (200c); in other examples, there may be additional, fewer and/or other sites. Each site is considered a failure domain 210a, 210b, 210c of one another, and each failure domain is a candidate system of a set of candidate systems to be considered to deploy an application from a failed failure domain.

A candidate system is, for instance, any system capable of hosting a disaster recovery-protected application. A set of candidate systems includes, for instance, a system to which an application is currently deployed and one or more other systems with access to data of the application (e.g., one or more volumes of the application and/or replicas of the volume(s)). A candidate system that has a replica of the data may not have the most up-to-date data, if the data is replicated asynchronously.

Each candidate system has a set of system statistics related thereto, including, for instance, one or more recovery point-related objectives and one or more recovery time-related objectives. As examples, the recovery point-related objectives include a recovery point objective (RPO), which is a maximum tolerable time between its copy of the data and its primary's copy of the data, and/or a recovery point actual (RPA), which is the time between its copy of the data and its primary's copy of the data. The primary's copy of the data is assumed to be from the time of disaster detection, in the event of a disaster. In one example, the recovery point objective indicates how much data loss can be tolerated within a selected time period. The recovery point actual indicates the time elapsed since a last successful recovery point. It helps derive an amount of data that might be lost when performing a failover. Recovery point-related objectives may include additional, fewer and/or other objectives.

As examples, the recovery time-related objectives include, for instance, past or historical recovery times, current resource availability, and/or degree of application recovery completed. Recovery time-related objectives may include additional, fewer and/or other objectives.

Recovery time is, for instance, the time from the beginning of an event (e.g., disaster) to successful completion of recovery on the system selected for recovery. In one example, past recovery times of an application are disaster protected, enabling this information to be available in the event of a disaster.

Current resource availability facilitates determining whether there are sufficient resources (e.g., central processing units (CPUs), memory, disk capacity, storage, input/output (I/O) bandwidth, and/or I/O latency, etc.) to enable the application to perform well. The resources are considered system statistics herein (e.g., performance-related system statistics that may affect recovery time and/or post-recovery performance). Excessive resource availability may not improve application performance. By default, a system statistic has a realistic upper bound. If a system's resources or performance exceeds this bound, it is capped to the upper bound. For example, assume an upper bound on CPU cores is 100. If system X's CPU count is 128, it is scored (described below) as if it has 100 cores. Other examples are possible. The current resource availability attribute may also consider historical values, as a single point in time may lead to inaccuracies. This is still represented as a single value for scoring purposes.

The degree of application recovery completed represents the state of the application during recovery. For instance, when performing disaster recovery of an application on a candidate system, the application that is to be recovered may be in one of the following states: cold: application not yet installed or deployed; warmer: only some parts of the application are deployed but inactive; warm: all parts of the application are installed or deployed but are inactive; hot: all parts of the application are installed, deployed and active. Additional, fewer and/or other states may be indicated.

In one example, each state may be converted to a value for scoring. As examples, cold: 25, warm: 50, warmer: 75, hot: 100. If system A is warm, a value of 50 is returned. Additional, fewer and/or other examples of states and/or scoring values are possible.

The set of system statistics may include additional, fewer and/or other system statistics. For instance, in one example, it includes estimated post-recovery resource availability (e.g., estimated resource availability, such as estimated storage capacity, other estimated system resources, etc.).

Continuing with FIG. 2, in one example, if Application (App) A 220 executing on site 2 (200b) fails due to, for instance, an event (e.g., a disaster or other event), App A may failover to failure domain 210a or failure domain 210c, or it may stay in failure domain 210b. The selection of a failure domain (or candidate system) is based on selected goals, including, but not limited to, minimizing application downtime, minimizing data loss and/or maintaining application performance. Two goals, data loss and recovery time estimate, are shown in the example depicted in FIG. 2.

In one example, if App A 220 is moved to failure domain (or candidate system) 210a, data loss 250a is considered medium and recovery time estimate 252a is considered low; and if moved to failure domain (or candidate system) 210c, data loss 250c is considered low and recovery time estimate 252c is considered medium. Further, if App A 220 stays at failure domain (or candidate system) 210b, then data loss 250b is zero but recovery time estimate 252b is considered high. Thus, in this example, data loss and recovery time estimate are considered in determining where to recover App A 220. However, in accordance with one or more aspects, additional, fewer and/or other goals may be considered, as well as one or more system statistics and/or user-defined information, as described herein.

Although example values for data loss and recovery time estimate are provided herein, these are only examples. The values are determined, e.g., based on selected indications; based on a range; relative to other values, etc. Additional, fewer and/or other values and/or value types may be used. Further, additional, fewer and/or other goals and/or information may be considered. Many examples and/or variations are possible.

In accordance with one or more aspects, a recovery capability is provided that includes dynamic selection of a candidate system of a set of candidate systems to deploy one or more applications based on a selected event, such as recovery from a disaster. The disaster may be, for instance, a natural disaster (e.g., earthquake; tsunami; flood; volcanic eruption; landslide; fire; weather related disaster, such as a hurricane, blizzard, tornado, cyclone, monsoon, etc.; and/or other natural disasters) and/or other types of disasters or selected events.

Based on a selected event occurring, recovery is to be performed for one or more applications. During recovery, selected goals are considered, such as minimizing application downtime and data loss, in selecting a system to be used in recovering an application. However, there may be tradeoffs between these goals and other goals, such as maintaining application performance. In one or more aspects, a comprehensive solution is provided (e.g., dynamically) that considers a plurality of criteria, including, e.g., one or more goals; one or more system statistics; and/or user-defined information, such as user-specified goals and/or user-identified statistics (e.g., a set of system statistics and/or other statistics (e.g., time of day, etc.) of importance to the user) and an identification of relative priority or importance to the user between those statistics.

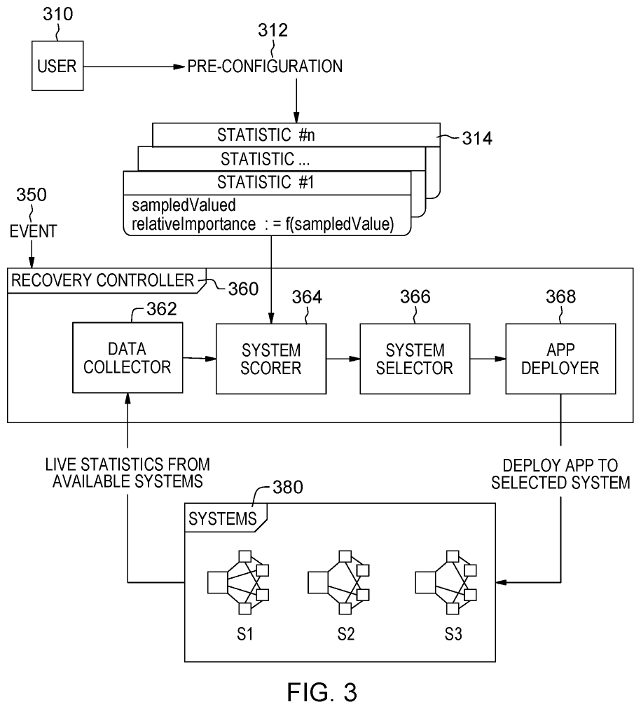

One example of considering and/or using a plurality of criteria in selecting a candidate system to be used in recovering an application is described with reference to FIG. 3. In one example, a user 310 (or one or more users) performs 312 pre-configuration, in which the user inputs user-defined information, such as relative importance of various system statistics 314 contributing to candidate system selection, and/or other information. The system statistics include, for instance, recovery point-related objectives, recovery time-related objectives, estimated post-recovery resource availability and/or other system statistics/statistics affecting recovery and/or post-recovery, as examples. In one example, for each user-identified statistic (or selected user-identified statistics), the user may specify (e.g., via the user-defined information) a valuation function (e.g., linear, logarithmic, exponential, etc.) and/or a normalize function used in scoring the statistic. Further, in one or more examples, the user may specify one or more weights indicating the relative importance of the statistic. Other examples are possible.

Based on a selected event 350, such as recovery from a natural disaster, a recovery controller 360 is initiated that obtains (e.g., collects) data, such as one or more system statistics. The one or more system statistics are collected, e.g., from one or more systems 380 (e.g., system 1 (S1), system 2 (S2), system 3 (S3)) and/or one or more data repositories using, e.g., a data collector 362. The one or more system statistics include, for instance, current data (e.g., current system statistics) and historical data (e.g., historical system statistics). As an example, the one or more system statistics include recovery point-related objectives (e.g., recovery point objective(s), recovery point actual(s), etc.); recovery time-related objectives (e.g., current resource availability; degree of application recovery completed; historical recovery time-related objectives, such as past recovery times, as an example, etc.); and/or estimated post-recovery resource availability, as examples. The obtained system statistics may include additional, fewer and/or other system statistics and/or other statistics.

In one example, the obtained data is forwarded to a system scorer 364 that scores each system for failover, including the current system. In one example, each candidate system is scored based on the user input (e.g., the user-defined information) and the collected data (e.g., system statistics). Based on the scores, a system selector 366 selects a candidate system from a set of candidate systems to be used for failover. As an example, the best candidate system is selected based on the scores. The best candidate system is defined, for instance, as the one with the lowest (or highest) score relative to the other candidate systems in the set of candidate systems. In other examples, the best candidate system is defined based on other indicators. For instance, it may be defined to be the one that has a predefined relationship with one or more of the indicators and another predefined relationship with one or more other indicators. Many examples and variations are possible.

In one example, recovery controller 360 also includes an application (App) deployer 368 to deploy the application on the selected candidate system indicated by system selector 366.

In one or more examples, the recovery controller is executed on a system (referred to as a leader system). The leader system is, for instance, one or more devices, such as one or more computers (e.g., computer(s) 101 and/or other computers); one or more servers (e.g., remote server(s) 104 and/or other servers); one or more end user devices (e.g., end user device(s) 103 and/or other end user devices); one or more processors or nodes (e.g., processor(s) or node(s) of processor set 110 and/or other processors or nodes); processing circuitry (e.g., processing circuitry 120 of processor set 110 and/or other processing circuitry); and/or other devices, etc. Additional and/or other computers, servers, end user devices, processors, nodes, processing circuitry and/or other devices may be selected as the leader system. Many examples are possible.

The leader system may be chosen before or after the selected event (e.g., natural disaster), and may be chosen manually (e.g., by a user, administrator, etc.) or automatically (e.g., by a process, using artificial intelligence or machine learning, etc.). In the case of using machine learning, a model is trained to select the leader system and re-trained based on current and/or learned information.

In one or more aspects, to perform recovery, a recovery controller, such as recovery controller 360, may use a recovery module, such as recovery module 150, to select a candidate system to be used for failover. In one example, a recovery module (e.g., recovery module 150) includes various sub-modules to be used to facilitate and/or perform recovery and/or tasks relating thereto. The sub-modules are, e.g., computer readable program code (e.g., instructions) in computer readable media, e.g., storage (persistent storage 113, cache 121, storage 124, other storage, as examples). Although, as an example, recovery module 150 is depicted in FIG. 1 in persistent storage 113, one or more sub-modules may be in other storage, etc. Many variations are possible.

The computer readable media may be part of one or more computer program products and the computer readable program code may be executed by and/or using one or more devices (e.g., one or more computers, such as computer(s) 101 and/or other computers; one or more servers, such as remote server(s) 104 and/or other servers; one or more end user devices, such as end user device(s) 103 and/or other end user devices; one or more processors or nodes, such as processor(s) or node(s) of processor set 110 and/or other processors or nodes; processing circuitry, such as processing circuitry 120 of processor set 110 and/or other processing circuitry; and/or other devices, etc.). Additional and/or other computers, servers, end user devices, processors, nodes, processing circuitry and/or other devices may be used to execute one or more of the sub-modules and/or portions thereof. Many examples are possible.

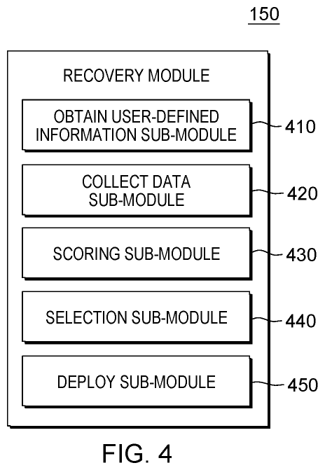

One example of sub-modules of recovery module 150 is described with reference to FIG. 4. As an example, recovery module 150 includes, for instance, an obtain user-defined information sub-module 410 to obtain, for instance, preferences of the user related to one or more goals and/or system statistics, etc.; a collect data sub-module 420 to collect data (e.g., system statistics) relating to the candidate systems available for failover; a scoring sub-module 430 to score the available candidate systems based on, e.g., the user-defined information and the collected data; a selection sub-module 440 to select a candidate system to be used for failover; and a deploy sub-module 450 to initiate deployment and/or deploy the application on the selected candidate system, in accordance with one or more aspects of the present disclosure. Additional, fewer and/or other sub-modules may be used to perform recovery and/or tasks related thereto. Other variations are possible. Although various sub-modules are described, a recovery module, such as recovery module 150, may include additional, fewer and/or different sub-modules. A particular sub-module may include additional code, including code of other sub-modules, less code, and/or different code. Further, additional and/or other modules may be used to facilitate recovery and/or perform related tasks. Many variations are possible.

In one example, data collector 362, system scorer 364, system selector 366 and app deployer 368 may be implemented using one or more of sub-modules 420-450. In other examples, other implementation techniques may be used. Many examples are possible.

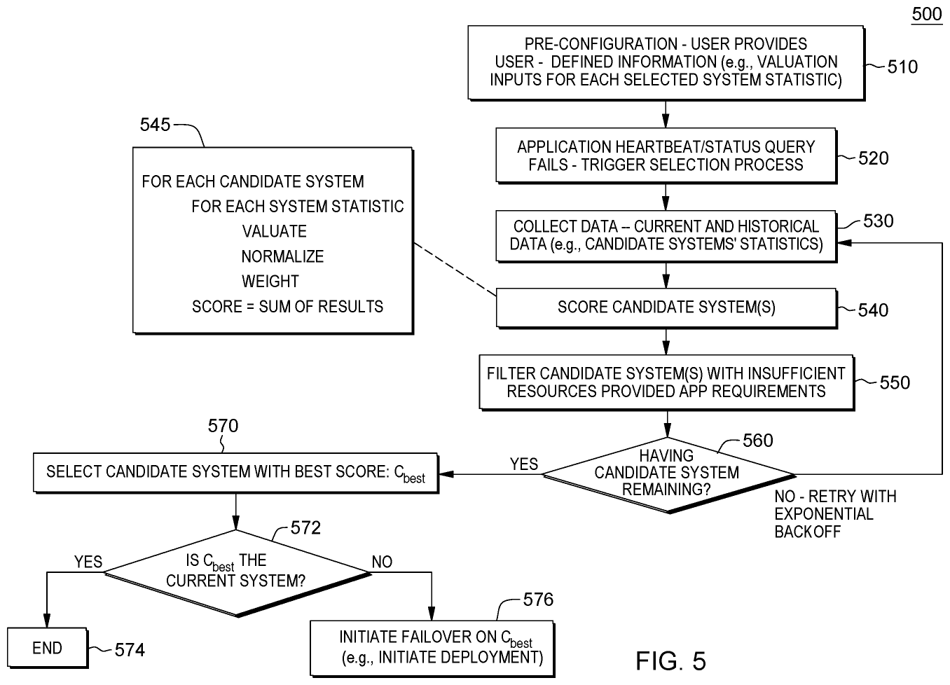

One or more of the sub-modules are used, as described herein, to select a candidate system to be used for failover and to initiate failover of an application on the selected candidate system, as described herein with reference to FIG. 5. In one example, a recovery process (e.g., a recovery process 500) is implemented using one or more of the sub-modules (e.g., one or more of sub-modules 410-450) and is executed by one or more devices (e.g., one or more computers (e.g., computer 101, other computer(s), etc.), one or more servers (e.g., server 104, other server(s), etc.), one or more end user devices (e.g., end user device 103, other end user device(s)), one or more processors, nodes and/or processing circuitry, etc. (e.g., of processor set 110 or other processor set(s)), and/or one or more other devices, etc.). Although example computers, servers, end user devices, processors, nodes, processing circuitry and/or devices are provided, additional, fewer and/or other computers, servers, end user devices, processors, nodes, processing circuitry and/or devices may be used for recovery and/or other processing. Various options are possible.

In one example, the recovery process is executed on the leader system. Other examples are also possible.

In one example, referring to FIG. 5, recovery process 500 (also referred to as process 500) includes, for instance, obtaining 510 user-defined information based on pre-configuration performed by one or more users. For example, one or more users provide user-defined information, such as valuation inputs (e.g., valuation function and/or weights) for one or more selected criteria that indicate, for example, the importance to a user of the one or more criteria. These criteria include, for instance, system statistics including, but not limited to, one or more recovery point-related objectives, one or more recovery time-related objectives, estimated post-recovery resource availability and/or other system statistics; selected goals relating to, for instance, application downtime, application recovery time and/or post recovery performance; and/or additional, fewer and/or other criteria, etc. As an example, this is provided prior to a selected event, such as recovery from a disaster. In another example, it may be provided subsequent to an occurrence of the event but prior to selecting the candidate system on which the application is to be recovered. Other examples are possible.

Process 500 obtains 520 an indication that an application has failed and/or an event has occurred. As examples, process 500 obtains this indication based on failure of an application heartbeat process and/or failure of a status query. If the heartbeat process or status query does not receive a response from the application or system on which it is running or receives some indication that failover is to be performed, process 500 continues with recovery.

In one example, as part of recovery, process 500 collects 530 data, such as current and historical data relating to one or more candidate systems of the set of candidate systems and/or related to the failover application. As an example, the data collected includes one or more system statistics (e.g., one or more current and/or historical system statistics) of the one or more candidate systems. The collected data includes, for instance, values representing, for instance, one or more recovery point objectives, one or more recovery point actuals, one or more past recovery times, current resource availability, a degree of application recovery completed and/or estimated post-recovery resource availability, as examples. Further, additional, fewer and/or other system statistics may be collected. This data (e.g., system statistics) is obtained from the candidate systems and/or retrieved from memory, storage and/or other accessible locations, as examples.

Based on the obtained user-defined information and the collected data, process 500 scores 540 each candidate system (or selected candidate systems). As an example, for a candidate system, valuation, normalization and/or weighting 545 are performed for each system statistic (or selected system statistics) and the results are added to provide a score for the candidate system. The valuation is performed using a function, such as linear, logarithmic, exponential, etc., which may be provided as a user preference, as a default, or determined by the process using, e.g., machine learning, etc. Normalization places the statistical values on the same level (e.g., same type or format). The weighting factors in the preferences of the one or more users. As an example, each preference is a value between 0 and 1. Other values are also possible. Further details are provided below.

One example of normalization is range normalization in which all values linearly map to, e.g., [0, 100] after defining a maximum value. A general formula includes, for instance—for output range [X1, X2] and input range [x1, x2] with input x and output X, X=X1+ ({X2−X1}/{x2-x1}) (x-x1). If the output range is capped to [0, 100] and x1=0 is used, a maximum range per value is defined in order to map it to the selected dimension, and to use X=(100/x2)*X.

Example 1: Maximum cores cap at 128; so a system with 16 cores would have a score of X=(100/128)*16=12.5.

Example 2: Maximum memory caps at 256 GB; so a system with 60 GB free memory would have a score of X=(100/256)*60=23.4375.

Example 3: Maximum I/O bandwidth (BW) cap is 4000 MB/s; so a system with a bandwidth of 200 MB/s would have a score of X=(100/4000)*200=5. Many examples are possible. Further, other normalization equations and/or techniques may be used.

In one example, one or more system statistics (and/or goals, etc.) are multiplied by one or more weights.

In one example, weights determine relative value of the system statistics (and/or goals, etc.). As the quantity of a particular system statistic (and/or goal, etc.) increases or decreases, its value may not change proportionally. As examples: each increase in CPUs may benefit an application until a ceiling is reached where additional CPUs provide little to no benefit; the most recent, e.g., 5 minutes of recovery point may be more valuable than minutes prior; etc. Each system statistic (and/or goal) may be valuated by a function before being multiplied by its weight. Example functions include: Linear (e.g., default): f (a)=a; linear with ceiling (increases up to some limit): f(a)=max (a, a_{ceiling}); logarithmic (diminishing returns): f(a)=log(a); and a combination: f(a)=max (log (a), a_{ceiling}). Additional, fewer and/or other functions may be specified and/or used.

Example terms used herein may include, e.g.: system statistic=a, e.g.: recovery point actual, recovery point objective, free CPUs, free GBs of memory, etc. Valuated system statistic=valuate (a)—valuated by a function. Factor=F(a)—Valuated and normalized system statistic; F(a)=normalize (valuate (a)). System statistic weight=w(a)—relative value of valuated system statistic; valid values range from, e.g., 0 to 100%; sum of all weights is to equal, e.g., 100%. Weighted Factor: F_{weighted}(a)=F(a)*w(a). Other examples and variations are possible.

In one example, the scoring process converts system statistics and/or goals or other criteria of different units and scales to unitless values and combines them to produce a single system score. One example of a scoring equation includes:

$${Score}_{i} = {\sum }_{j = 1}^{n} {Factor}_{j} * weightj$$

where:
i=current system (index/iterator), n=total number of systems, j=current factor index;
Statistics: recovery point actual, resource availability, etc., value as reported by the systemᵢ; and
Weights: relative importance of individual factors, as determined a priori by, e.g., user. In other examples, machine learning and/or artificial intelligence may be used to determine the weights.

In one example, the total sum of weights is to equal 1 for normalization, or Σⱼ₌₁ⁿ=weightj=1.

In one example, a lower score implies a more suitable candidate system; however, a score inversion process may be used for a higher value score to imply better suitability. Other examples are possible.

In one example, lower scores are considered better (lower-is-better units) for some system statistics, including time measurements (e.g., recovery point actual, I/O response time, etc.), while higher scores are better (higher-is-better units) for others, including resource availability (e.g., CPU cores, I/O bandwidth, etc.). Thus, in one example, in using a lower score to select a most suitable (e.g., best) candidate system, higher-is-better units are converted to lower-is-better units by subtracting their values from a maximum. For example, assume a maximum number of CPU cores is 100, then a candidate system with 60 cores available is converted to 100−60=40, and another candidate system with 20 cores available is converted to 100−20=80. Other examples are possible.

In one example, as the quantity of a particular statistic increases or decreases, its value may not change proportionally. A valuation function is used to convey appropriate value (e.g., with linear, exponential, logarithmic, etc.). Other examples are possible.

One particular example of scoring includes:
System statistic weights input by user: RPA weight=0.6; Latency weight=0.4.
System 1 statistics: RPA=10; Latency=5.

$${Score}_{system 1} = ( 10 * 0.6 ) + ( 5 * 0.4 ) = 6 + 2 = 8 .$$

Although the above scoring equation and/or scoring technique is used, other scoring equations and/or techniques may be used. Further, additional, fewer and/or other system statistics and/or criteria may be weighted. Other examples are possible.

In one example, process 500 filters 550 the candidate system(s), if any, that have insufficient resources given requirements of the application that is to failover. Based on the filtering, process 500 determines 560 whether there are any candidate systems remaining that have sufficient resources (e.g., CPUs, memory, I/O bandwidth, and/or other selected resources) to execute the application. Should there be no remaining systems, then process 500 returns to collecting data (e.g., system statistics) of the candidate systems. In one example, a retry is performed with exponential backoff. Exponential backoff is a retry mechanism, where every time a failure occurs and the system is to retry the operation, the period of time between attempts, e.g., doubles (e.g., first try=1 second, second try=2 seconds, third try=4 seconds, fourth try=8 seconds, etc.), or is multiplied by some constant or exponent. It is used as an efficient mechanism to keep retrying when it is unknown how long an error or network downtime may persist.

However, if there are remaining candidate systems 560, then process 500 selects 570 a candidate system to which failover is to be performed. In one example, process 500 selects the candidate system with the best score (e.g., the lowest score, in one example).

Process 500 determines 572 if the selected candidate system is the current system. If the selected candidate system is the current system, then process 500 ends 574. The application is restarted on the current system when the current system is available. However, if the selected candidate system is not the current system, then process 500 initiates 576 failover on the selected candidate system. In one example, this includes initiating deployment of the application on the selected candidate system, in order for the application to be deployed and executed on the selected candidate system. Deployment/execution on the selected candidate system includes, for instance, taking steps to make the target application(s) operable on the candidate system. This may include, for instance: mounting data volumes that have been replicated to the candidate system, providing data from a remote source to the candidate system, re-creating system components and configuration, etc.

One example of pseudocode for a recovery process includes, for example:
#systems: includes all failover system targets and current system
systemScores={ }
for system in systems:
values=getSystemValues(system) #values: dictionary of all scored statistics
systemScores[system]=scoreSystem(values)
systemBest=indexOf(min(systemScores))
if systemBest!=currentSystem:
startFailover(systemBest)
#implicit else: stay on current system; do not fail over.

Examples of using the recovery process include:

Example A: Weights: recovery point actual (RPA)=50%; past recovery times=10%; application recovery completed=10%; current resource availability=15%; free CPU, memory, disk and network latency are 25% each of current resource availability.

| SYSTEM STATISTIC | SITE 1 | SITE 2 | SITE 3 | SITE 4 |
|---|---|---|---|---|
| RPA | 5 | 1 | 10 | 1.1 |
| Past Recovery Times | 30 | 15 | 10 | 20 |
| App Recov. Completed | 50 | 100 | 25 | 75 |
| Free CPU cores | 12 | 8 | 16 | 10 |
| Free Memory (GB) | 8 | 8 | 128 | 4 |
| Free Disk (GB/s) | 8 | 2 | 16 | 1 |
| Network Latency (MS) | 43 | 10000 | 70 | 10 |
| Final Score | 23.4499 | 12.1038 | 26.0694 | 17.1858 |

In this example, Site 2 is the current site and based on the final score (where the best score is the lowest score compared to the other scores), it is recommended that the application stay on the current site (e.g., site 2). Although certain system statistics are included in the example, additional, fewer and/or other system statistics and/or other criteria may be considered. Further, although certain values are used, other values may be used. Many examples and variations are possible.

Example B: Weights: recovery point actual (RPA)=50%; past recovery times=10%; application recovery completed=10%; current resource availability=15%; free CPU, memory, I/O bandwidth and network latency are 25% each of current resource availability.

| SYSTEM STATISTIC | SITE 1 | SITE 2 | SITE 3 | SITE 4 |
|---|---|---|---|---|
| RPA | 5 | 1 | 10 | 1.1 |
| Past Recovery Times | 30 | 15 | 10 | 20 |
| App Recov. Completed | 50 | 100 | 25 | 100 |
| Free CPU cores | 12 | 8 | 16 | 10 |
| Free Memory (GB) | 8 | 8 | 128 | 4 |
| Free Disk (GB/s) | 8 | 2 | 16 | 1 |
| Network Latency (MS) | 43 | 10000 | 70 | 10 |
| Final Score | 23.4499 | 12.1038 | 26.0694 | 10.9358 |

In this example, Site 2 is the current site and based on the final score (where the best score is the lowest score compared to the other scores), it is recommended that the application failover to Site 4. Although certain system statistics are included in the example, additional, fewer and/or other system statistics and/or other criteria may be considered. Further, although certain values are used, other values may be used. Many examples and variations are possible.

Other examples are possible including additional, fewer and/or other sites; additional, fewer and/or other system statistics and/or other criteria; and/or other values. Many variations are possible.

In one or more aspects, a capability is provided to facilitate processing within a computing environment by providing an intelligent selection of a disaster recovery site (a candidate system) for a stateful application (e.g., application that has state). The recovery process considers a plurality of goals in determining which candidate system is to be selected to execute an application based on a selected event. The plurality of goals includes, for instance, minimizing data loss and application downtime, and maintaining recovery and/or post-recovery performance. To facilitate reaching the goals, one or more system statistics, one or more user-specified system statistics and/or other criteria are considered. In one or more aspects, the recovery process collects, valuates, normalizes and weights factors, and based thereon, selects a candidate system to execute the application.

In one or more aspects, the recovery process is based on a template that is intentionally transparent. The template provides an indication of the information (e.g., goals, system statistics, user-specified system statistics, factors and/or other criteria, etc.) to be obtained and are considered, and an interface in which to obtain the information. It makes clear the information to be obtained and how it is to be used.

In one or more aspects, the application is stateful in that there is application state (data) to lose. As an example, the application state may be disaster protected using, for instance, backup/disaster recovery in which the state is replicated to one or more intermediate locations pre-selected of the event and restored to an application host system (selected system) post-selected of the event; and/or disaster recovery in which state is replicated to a system capable of hosting the application pre-selected of events. One or more aspects of the recovery process, described herein, are not tied to these disaster protection techniques.

In one or more aspects, a plurality of possible failure scenarios across multiple sites (candidate systems) is provided, as well as conditional logic to select the best available option from among the multiple sites (candidate systems).

One or more aspects of the present disclosure are tied to computer technology and facilitate processing within a computer, improving performance thereof. For instance, processing within a computing environment is improved by providing a capability to facilitate recovery that reduces application performance loss and/or data loss and improves the time for recovery. In one or more aspects, based on a selected event (e.g., a natural disaster) affecting a particular system of a computing environment, one or more applications of the particular system are recovered. Recovery includes automatically selecting, based on the selected event, a candidate system of a plurality of candidate systems in which to execute the one or more applications. The selected candidate system may be the same system or another candidate system. If the same system is selected, one or more actions are performed to enable the application to execute on that candidate system. For instance, the candidate system is restarted, repaired and/or physically moved, volumes are mounted, back-ups are performed, and/or any other actions are taken to be able to use the candidate system. Based on the candidate system being physically ready to run the one or more applications, the one or more applications are started on the candidate system and executed. By choosing the same system as the candidate system, data loss is eliminated (or significantly minimized), saving processing time and system resources. For instance, processing time and system resources are saved by avoiding repeated processing to re-create the data and/or by avoiding tasks that may be performed to deploy the one or more applications on a different candidate system.

If a candidate system different from the particular system affected by the selected event is selected, then one or more actions are performed to be able to deploy and execute the one or more applications on the selected candidate system. For instance, one or more data volumes may be mounted, data and/or components/modules may be provided to the selected candidate system and installed, and/or the one or more applications are installed, etc. Thereafter, the one or more applications are executed on the selected candidate system. The candidate system selected may improve processing within the computer by executing the one or more applications. Performance within the computing environment is improved by quickly recovering and executing the one or more affected applications. Performance within the computing environment is improved, based on selecting a candidate system that minimizes data loss, since repeated processing that would be performed to re-create the data is minimized, saving processing time within the computer, as well as processing resources. Processing within a processor, computer system and/or computing environment is improved.

In one or more aspects, technological advances, such as cloud technologies that make certain resources, like storage, highly available without being tied to a particular location and/or highly available with different degrees of data loss depending on the location, demonstrate a use for such a recovery solution that dynamically selects a candidate system for failover based on a plurality of criteria or metrics.

In one or more aspects, a multi-criteria problem is solved, which is increasingly beneficial with recovery points in multiple regions, including the cloud.

In one or more aspects, a system is recommended to recover an application at disaster time by considering, for instance, actual recovery points, predicted recovery time, and recovery system historical data. Data loss is limited by considering actual recovery point (RPA) ranges even if the recovery point objective (RPO) is met. For instance, RPO is 15 minutes, but RPA is 3 minutes for System A and 14 minutes for System B. Further, in one or more aspects, recovery performance is estimated based on historical measurements. Yet further, in one or more aspects, a disaster recovery plan is executed by selecting a selected failover system (candidate system) factoring in the degree to which it meets or exceeds each objective weighted relative to other factors and valuated by a function.

In one or more aspects, data loss and application downtime are reduced, at disaster time, by considering, for instance, the age of each data replica and the current state of the system attached to it.

One or more aspects optimize for certain goals: e.g., the minimization of application downtime, the minimization of data loss, and the retention of application performance after failover occurs. In one or more aspects, the user may select certain information that is to be considered in failover. For instance, the user may select one or more system statistics and/or user-defined information. The user-defined information includes, e.g., one or more user-identified statistics, such as one or more system statistics and/or other statistics (e.g., time of day, etc.), the user desires to have considered along with relative importance of the user-identified statistic to the user. A standardized approach is provided to score the selected information and to use those scores to select a candidate system. Further, disparate values may be compared across the systems for fair comparisons and a weighting scheme that is customizable by users depending on their needs is provided.

In one or more aspects, the capability is not limited to a particular configuration, and considers additional criteria when making a failover recommendation; e.g., optimizing for a minimization of data loss, minimization of recovery time, etc. One or more aspects may be generalized across different users with different needs.

In one or more aspects, one or more criteria from which a decision may be made are considered, including, for instance, minimization of application downtime, and the continuity of application performance after the workload transfer. Further, a weighting mechanism for failover attributes is provided that allows a user to emphasize or de-emphasize characteristics that are desired for a particular application and define additional criteria by which a failover decision should be evaluated. In one or more aspects, criteria are continuously evaluated and include both current and historical performance levels when making decisions.

In one or more aspects, multiple failover choices are offered, and the best failover target recovery system (candidate system) is selected in the event of a disaster.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

Yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other techniques may be used to select a candidate system, perform recovery and/or perform one or more other aspects of the present disclosure. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
at least one computer readable storage medium and program instructions collectively stored on the at least one computer readable storage medium, the program instructions collectively stored comprising:
program instructions to obtain user-defined information relating to recovery of an application based on a selected event;
program instructions to obtain data relating to a set of candidate systems available to deploy the application, the data including one or more system statistics for the set of candidate systems, the one or more system statistics including, at least, one or more recovery point actuals and historical data for the set of candidate systems;
program instructions to perform a scoring of the set of candidate systems based on the user-defined information and the data that is obtained;
program instructions to select a candidate system from the set of candidate systems based on the scoring; and
program instructions to initiate deployment of the application on the candidate system that is selected.

2. The computer program product of claim 1, wherein the user-defined information includes relative importance to a user of at least one system statistic of the one or more system statistics of one or more candidate systems of the set of candidate systems.

3. The computer program product of claim 1, wherein the user-defined information includes one or more user-identified statistics.

4. The computer program product of claim 3, wherein the one or more user-identified statistics include an indication of a valuation function to be used to valuate at least one system statistic of the one or more system statistics of one or more candidate systems of the set of candidate systems.

5. The computer program product of claim 1, wherein the one or more system statistics further include one or more resource availability metrics for a set of system resources for at least one candidate system of the set of candidate systems.

6. The computer program product of claim 5, wherein the set of system resources includes memory, one or more central processing units, input/output bandwidth and latency.

7. The computer program product of claim 1, wherein the one or more system statistics further include a degree of completed recovery for the application.

8. The computer program product of claim 1, wherein the program instructions to obtain the data include program instructions to obtain the data based on occurrence of the selected event.

9. The computer program product of claim 1, wherein the set of candidate systems includes a current system on which the application is deployed and one or more other candidate systems.

10. The computer program product of claim 1, wherein the application is a stateful application, and application data of the application is protected using one or more data protection techniques, and wherein selection of the candidate system is independent of the one or more data protection techniques.

11. The computer program product of claim 1, wherein the scoring is based on selected data relating to application downtime, current resource availability of the set of candidate systems, time it takes to recover the application, post-recovery performance and estimated post-recovery resource availability.

12. The computer program product of claim 1, wherein the program instructions to perform the scoring include program instructions to perform a weighting of at least one system statistic of the one or more system statistics based on the user-defined information to obtain one or more weighted values, and wherein the program instructions to perform the scoring include program instructions to use the one or more weighted values in the scoring.

13. The computer program product of claim 1, wherein the historical data includes one or more historical recovery time statistics for one or more candidate systems of the set of candidate systems.

14. The computer program product of claim 1, wherein the one or more recovery point actuals include at least one recovery point actual for each candidate system of the set of candidate systems.

15. The computer program product of claim 1, wherein the selected event is disaster recovery from a natural disaster.

16. A computer system for facilitating processing within a computing environment, the computer system comprising:
a memory; and
at least one device coupled to the memory, wherein the computer system is configured to perform a method, the method comprising:
obtaining user-defined information relating to recovery of an application based on a selected event;
obtaining data relating to a set of candidate systems available to deploy the application, the data including one or more system statistics for the set of candidate systems, the one or more system statistics including, at least, one or more recovery point actuals and historical data for the set of candidate systems;
performing a scoring of the set of candidate systems based on the user-defined information and the data that is obtained;
selecting a candidate system from the set of candidate systems based on the scoring; and
initiating deployment of the application on the candidate system that is selected.

17. The computer system of claim 16, wherein the user-defined information includes relative importance to a user of at least one system statistic of the one or more system statistics of one or more candidate systems of the set of candidate systems.

18. The computer system of claim 16, wherein the scoring is based on selected data relating to application downtime, current resource availability of the set of candidate systems, time it takes to recover the application, post-recovery performance and estimated post-recovery resource availability.

19. The computer system of claim 16, wherein the performing the scoring includes performing a weighting of at least one system statistic of the one or more system statistics based on the user-defined information to obtain one or more weighted values, and wherein the performing the scoring includes using the one or more weighted values in the scoring.

20. The computer system of claim 16, wherein the application is a stateful application, and application data of the application is protected using one or more data protection techniques, and wherein selection of the candidate system is independent of the one or more data protection techniques.

21. A computer-implemented method of facilitating processing within a computing environment, the computer-implemented method comprising:
obtaining user-defined information relating to recovery of an application based on a selected event;
obtaining data relating to a set of candidate systems available to deploy the application, the data including one or more system statistics for the set of candidate systems, the one or more system statistics including, at least, one or more recovery point actuals and historical data for the set of candidate systems;
performing a scoring of the set of candidate systems based on the user-defined information and the data that is obtained;
selecting a candidate system from the set of candidate systems based on the scoring; and
initiating deployment of the application on the candidate system that is selected.

22. The computer-implemented method of claim 21, wherein the user-defined information includes relative importance to a user of at least one system statistic of the one or more system statistics of one or more candidate systems of the set of candidate systems.

23. The computer-implemented method of claim 21, wherein the application is a stateful application, and application data of the application is protected using one or more data protection techniques, and wherein selection of the candidate system is independent of the one or more data protection techniques.

24. The computer-implemented method of claim 21, wherein the scoring is based on selected data relating to application downtime, current resource availability of the set of candidate systems, time it takes to recover the application, post-recovery performance and estimated post-recovery resource availability.

25. The computer-implemented method of claim 21, wherein the performing the scoring includes performing a weighting of at least one system statistic of the one or more system statistics based on the user-defined information to obtain one or more weighted values, and wherein the performing the scoring includes using the one or more weighted values in the scoring.
